(19) United States
(12) Patent Application Publication
(10) Pub. No.: US 2003/0022580 A1
(43) Pub. Date: Jan. 30, 2003

(54) Insulation batt and method of making the batt

(76) Inventors: Blake B. Bogrett, Littleton, CO (US); Robert J. Allwein, Highlands Ranch, CO (US); Larry J. Weinstein, Littleton, CO (US)

Correspondence Address: Robert D. Touslee, Johns Manville Corporation, 10100 West Ute Avenue, Littleton, CO, 80127, US

(21) Appl. No.: 09/912,290

(22) Filed: Jul. 24, 2001

(51) Int. Cl. D04H 1/00; D04H 3/00; D04H 5/00; D04H 13/00; B29B 9/00; C03B 37/04

(52) U.S. Cl. 442/327; 442/331; 442/333; 65/455; 264/6

(57) ABSTRACT

Resilient fibrous insulation batts are formed with the fibers of the batts being randomly oriented and entangled together and predominately lying in planes that extend substantially perpendicular to the major surfaces and the end surfaces of the batts and substantially parallel to the lateral surfaces of the batts to facilitate a widthwise compression of the batts. The batts are formed by collecting fibers into a blanket with the fibers being collected in layers lying in planes extending substantially parallel to the major surfaces of the blanket and the blanket having a thickness equal to the widths of the batts to be formed. The blanket is then cut longitudinally and transversely, in directions perpendicular to the major surfaces of the blanket, into sections having thicknesses and lengths equal to those of the batts to complete the formation of the batts.

### BACKGROUND OF THE INVENTION

The present invention relates to resilient, fibrous insulation batts, and, in particular, to resilient fibrous insulation batts that are more easily compressed in the direction of their width to fit into wall and other building cavities having widths less than the widths of the batts and a method of making such batts.

Building structures, such as residential houses, industrial buildings, office buildings, mobile homes, prefabricated buildings and similar structures, typically include walls (both interior and exterior), ceilings, floors, and roofs that are insulated for thermal and/or acoustical purposes, especially exterior walls, the ceilings below open attic spaces, and the roofs of such structures. The walls, ceilings, floors and roofs of these structures include framing members, e.g. studs, rafters, floor and ceiling joists, beams and similar support or structural members which are normally spaced-apart standard distances established by the building industry. Sheathing, paneling, lathing or similar construction materials are secured to these framing members to form the walls, ceilings, floors and roofs of the structures. While the builder or contractor seeks to maintain the spacing of the framing members in these structures at these standard distances for ease of construction and the insulation of the elongated cavities formed in these walls, ceilings, floors and roofs, frequently, the walls, ceilings, floors and roofs of these structures include elongated cavities defined, at least in part, by successive or adjacent framing members which are spaced-apart nonstandard distances less than the standard distance between framing members. Studies have shown that a typical residential home, it is not uncommon for 25% or more of the framing members in the exterior walls of these structures to be spaced-apart at nonstandard distances less than the standard distance for such framing members. Thus, there has been a need for providing contractors with insulation batts that can be quickly and easily installed in a structure to insulate both standard and many nonstandard width cavities without the need to cut the insulation batts with a knife or other cutting tool to fit the cavities of nonstandard widths.

### SUMMARY OF THE INVENTION

The insulation batt of the present invention provides a solution to the problem discussed above. The resilient fibrous insulation batt of the present invention can be compressed more easily in the direction of its width than normal insulation bafts. The resilient fibrous insulation batt of the present invention is formed with the fibers of the batt (preferably glass fibers) being randomly oriented and entangled together and predominately lying in planes that extend perpendicular and/or substantially perpendicular (hereinafter the term “substantially perpendicular” means perpendicular and/or substantially perpendicular) to the major surfaces and the end surfaces of the batt and parallel and/or substantially parallel (hereinafter the term “substantially parallel” means parallel and/or substantially parallel) to the lateral surfaces of the batt to facilitate a widthwise compression of the balts. The batts are formed by collecting fibers into a blanket with the fibers being collected in layers lying in planes extending substantially parallel to the major surfaces of the blanket. This is a conventional method of forming fibrous insulation blankets, e.g. in rotary fiberization processes. However, instead of forming the blanket to the thickness of the batts to be formed from the blanket or a thickness greater than the thicknesses of the batts to be formed from the blanket and later severing the blanket parallel to the major surfaces of the blanket into two blankets having the selected thicknesses of the batts to be formed from the blanket, in the process or method of the present invention, a blanket is formed having a thickness equal to the width of the balts to be formed from the blanket. The blanket is then cut longitudinally and transversely, in directions perpendicular to the major surfaces of the blanket, into sections having thicknesses and lengths equal to those of the batts to complete the formation of the batts.

With the conventional method of forming batts from the fibrous blanket, since the blanket has a thickness equal to the thickness of the balts being formed from the blanket, the blanket is cut longitudinally and transversely, in directions perpendicular to the major surfaces of the blanket, into sections having widths and lengths equal to those of the batts to complete the formation of the batts. Accordingly, the fibers which predominately lie in planes extending substantially parallel to the major surfaces of the blanket from which the batts are formed, also lie predominately in planes extending substantially parallel to the major surfaces of the batts formed from the blanket. By contrast, with the method of manufacture of the present invention, the fibrous insulation blanket is formed to a thickness equal to the width of the batts being formed from the blanket and the blanket is then cut longitudinally and transversely, in directions perpendicular to the major surfaces of the blanket, into sections having thicknesses and lengths equal to those of the balts to complete the formation of the batts. Accordingly, the fibers which predominately lie in planes extending substantially parallel to the major surfaces of the blanket from which the batts are formed, lie predominately in planes extending substantially perpendicular to the major surfaces of the batts formed from the blanket. Since these resilient batts are more easily compressed in directions substantially perpendicular to the planes within which the fibers of the batts predominately lie, batts made by the method of the present invention with the fibers lying predominately in planes extending substantially perpendicular to the major surfaces and end surfaces of the bafts and substantially parallel to the lateral surfaces of the batts compress more readily in the widthwise direction than balts made by the prior art process wherein the fibers of the batts lie predominately in planes extending substantially parallel to the major surfaces of the balts and substantially perpendicular to the lateral surfaces of the batts.

### BRIEF DESCRIPTION OF THE DRAWINGS

FIG. 1 is a schematic side view of a manufacturing line for making the resilient, fibrous insulation balt of the present invention.

FIG. 2 is a schematic vertical, transverse cross section through the fiberizing station of the manufacturing line of FIG. 1, taken substantially along lines 2—2 of FIG. 1.

FIG. 3 is a schematic plan view of the cutting stations of the manufacturing line of FIG. 1.

FIG. 4 is a schematic perspective view of a portion of a resilient, fibrous insulation blanket from which the resilient fibrous insulation batts of the present invention are made, such as a blanket laid down in the fiberizing station of the manufacturing line of FIGS. 1 to 3, prior to the cutting of the blanket.

FIG. 5 is a schematic perspective view of a series of resilient, fibrous insulation balts formed, in accordance with the method of the present invention, from the blanket of FIG. 4.

FIG. 6 is a schematic perspective view, on a larger scale than FIGS. 4 and 5, of a resilient, fibrous insulation batt of the present invention.

FIG. 7 is a schematic perspective view of a resilient, fibrous insulation batt of the prior art.

FIG. 8 is a schematic perspective view, on a smaller scale than FIG. 7, of a series of resilient fibrous insulation batts formed, in accordance with a method of the prior art, from a blanket such as a blanket that can be laid down in the fiberizing station of the manufacturing line of FIGS. 1 to 3.

### DESCRIPTION OF THE PREFERRED EMBODIMENTS

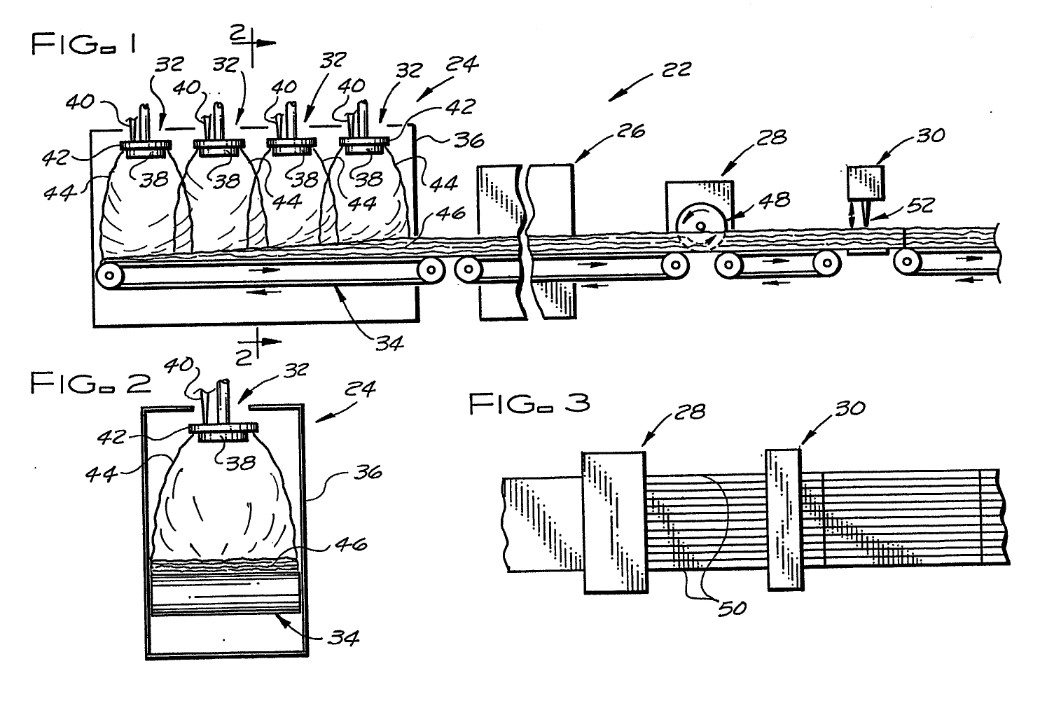

FIGS. 1 to 3 schematically show a manufacturing line for use in a preferred method of making the resilient fibrous insulation batt 20 of the present invention. As shown in FIGS. 1 to 3, a manufacturing line 22 for producing the resilient fibrous insulation batt of the present invention includes: a fiberizing and fiber collection station 24; a curing oven 26; a first cutting station 28; and a second cutting station 30. Typically, the manufacturing line 22 would also include a packaging station (not shown) for packaging the resilient fibrous insulation batts into packages containing a plurality of batts, e.g. 6 or, more batts, in a compressed condition for storage, transportation and handling prior to installation.

As best shown in FIGS. 1 and 2, the fiberizing and fiber collection station 24 includes: a plurality of rotary fiberizers 32 and an air permeable collection conveyor 34 which are housed within a collection chamber 36. Each of the rotary fiberizers 32 has a rapidly rotating spinner 38 that is supplied with a stream 40 of molten fiberizable material, e.g. glass. The rapidly rotating spinner 38 has an outer peripheral wall that typically contains tens of thousands of small diameter holes through which the glass is extruded by centrifugal force to form fibers. An air ring located immediately above the fiberizing holes in the spinner and downwardly discharging high velocity streams of air radially outward of the spinner and/or an annular burner located immediately above the fiberizing holes in the spinner and downwardly discharging high velocity streams of combustion gases radially outward of the spinner (the air ring and/or annular burner are designated by reference numeral 42) form a curtain 44 of high velocity gases surrounding the spinner 32 which engage the fibers formed by the spinner 32 and direct the fibers downward toward the collection conveyor 34 where the fibers are collected to form a resilient insulation blanket 46. While the entanglement of the fibers as the fibers are collected to form the resilient insulation blanket 46 may provide the blanket of fibers with sufficient integrity to hold the blanket together for packaging, handling and installation, a binder may be applied to the fibers, e.g. sprayed onto the fibers prior to the collection of the fibers on the conveyor to form the blanket, to increase the integrity of the blanket by bonding the fibers together at their points of intersection. The fibers are drawn down toward the upper surface of the air permeable collection conveyor 34 by exhaust fans (not shown), beneath the upper run of the conveyor, that draw air down through the upper run of the conveyor. U.S. Pat. No. 4,058,386, issued Nov. 15, 1977, is an example of a rotary fiberizing and collection station that may be used in a manufacturing line to form the resilient insulation blanket 46 from which the resilient insulation baits 20 of the present are made and the disclosure of U.S. Pat. No. 4,058,386 is hereby incorporated herein, in its entirety, by reference.

In the method of the present invention, the resilient fibrous insulation blanket 46, made in the fiberizing and collection station 24, has a thickness equal to or substantially equal to but somewhat greater than the width of the resilient fibrous insulation batts 20 to be formed from the blanket. When a binder is used, after the resilient fibrous insulation blanket 46 is formed in the fiberizing and collection station 24, the blanket 46 passes through the curing oven 26 where the binder is cured and on to the cutting stations 28 and 30. Of course, if binder is not applied to the fibers of the resilient, fibrous insulation blanket 46, the blanket can be fed directly into the cutting stations 28 and 30. In the cutting station 28, the blanket 46 is cut or severed longitudinally, e.g. by rotary saws 48 as the blanket 46 passes through the station 28, at spaced-apart locations across the width of the blanket into a series 50 of blanket sections having widths equal to the thicknesses of the resilient fibrous insulation batts 20 to be formed from the blanket and in the cutting station 30, the series 50 of previously formed blanket sections are periodically cut transversely, e.g. by a chopping blade 52 as the series 50 of blanket sections pass through the station 30, to the length of the resilient fibrous insulation batts 20 to complete the formation of the resilient fibrous insulation batts 20 from the blanket 46.

FIG. 4 schematically shows a portion of the resilient fibrous insulation blanket 46, from which the resilient fibrous insulation batts 20 are cut. The resilient fibrous insulation blanket 46 has a width in the “X” direction (the cross machine direction), a length in the “Y” direction (the machine direction or the direction of travel of the blanket along the manufacturing line), and a thickness in the “Z” direction. The resilient fibrous insulation blanket 46 is formed of layers 54 of randomly oriented, entangled fibers with the layers of fibers, as schematically shown in FIG. 4, extending in planes that are: substantially parallel to the major surfaces 56 of the blanket; substantially perpendicular to lateral surfaces 58 of the blanket that extend along the length of the blanket and between the major surfaces 56 of the blanket; and substantially perpendicular to a transverse plane, represented by surface 60 extending the width of the blanket and between the major surface of the blanket that would be formed by a transverse cutting of the blanket. With this layered structure, wherein the fibers predominately lie in planes extending substantially parallel to the major surfaces 56 of the blanket 46, the insulation blanket 46 is more easily compressed in the “Z” direction (perpendicular to the major surfaces 56 of the blanket 46) than in the “X” or “Y” directions parallel to the major surfaces of the insulation blanket 46.

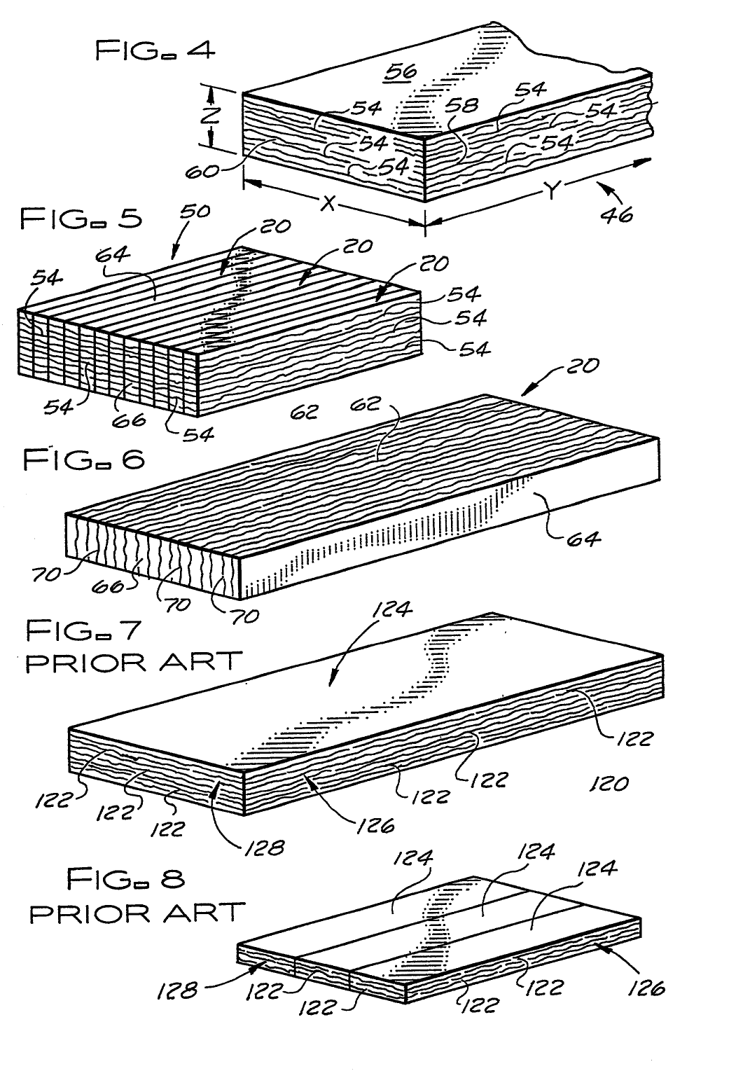

FIG. 5 schematically shows a series 50 of blanket sections that have been cut longitudinally in cutting station 28 to widths equal to the thicknesses of the resilient fibrous insulation bafts 20 and transversely in cutting station 30 to lengths equal to the lengths of the resilient fibrous insulation batts 20 to form a plurality of resilient fibrous insulation batts 20, such as the insulation batt 20 of FIG. 6. The resilient fibrous insulation bafts 20, formed from the blanket 46, each have major surfaces 62 that are substantially parallel with respect to each other and defined by the width and length of the batt lateral surfaces 64 that are substantially parallel with respect to each other and defined by the length and thickness of the balt, and end surfaces 66 that are substantially parallel with respect to each other and defined by the width and thickness of the batt. The fibers, which in the blanket 46 predominately laid in planes extending substantially parallel, to the major surfaces 56 of the blanket and substantially perpendicular to the lateral surfaces 58 and transverse planes 60 of the blanket 46, predominately lie in planes 70 extending substantially parallel to the lateral surfaces 64 of the baft 20 and substantially perpendicular to the major surfaces 62 and end surfaces 66 of the batt 20. With this structure, the batts 20 compress more easily in the direction of their width than prior art balt 120 of FIG. 7 wherein the fibers lie in planes 122 extending substantially parallel, to the major surfaces 124 of the batt and substantially perpendicular to the lateral surfaces 126 and end surfaces 128 of the batt 120. The balt 120 is made by laying down a blanket, in the fiberizing and collection station 24, having a thickness equal to the thickness of the insulation balts 120 cut from the blanket. As shown in FIG. 8, the blanket is then cut longitudinally to into sections having widths equal to the widths of the batts 120 and transversely into lengths equal to the lengths of the batts 120. By forming the blanket to the thickness of the batts 120 and cutting the blanket as described above, the balls have the same fiber orientation as the blanket, i.e. the fibers lie in planes 122 extending substantially parallel, to the major surfaces 124 of the balt and substantially perpendicular to the lateral surfaces 126 and end surfaces 128 of the batt 120.

While the resilient fibrous insulation blanket 46 and the resilient fibrous insulation balts 20 made from the blanket 46 may be made of other fibrous materials, preferably, the resilient fibrous insulation blanket 46 and batts 20 are made of glass fibers and have a density between about 0.4 pounds/ft³ and about 1.5 pounds/ft³. Examples of other fibers that may be used to form the resilient fibrous insulation blanket 46 and batts 20 are mineral fibers, such as but not limited to, rock wool fibers, slag fibers, and basalt fibers, and organic or synthetic fibers, such as but not limited to, polypropylene, polyester, and other polymeric fibers. The fibers of the resilient fibrous insulation blanket 46 and batts 20 may be bonded together for increased batt integrity, e.g. by a binder at their points of intersection, such as but not limited to urea phenol formaldehyde binder or other suitable bonding materials, or the resilient fibrous insulation blanket 46 and the batts 20 may be binderless provided the batts 20 possess the required integrity and resilience. In addition, the batts 20 may have facings, e.g. foil-scrim-kraft paper or kraft paper facings, bonded to one of the major surfaces of the batts to form a vapor barrier.

Due to its resilience the fibrous insulation batt 20 can be compressed to reduce the batt thickness for packaging, e.g. to a thickness about ¼to about ⅛of its original thickness, and contained in its compressed state in a package of typically six or more batts. When the resilient fibrous insulation batt 20 is removed from its package, the batt 20 recovers substantially to its pre-compressed thickness. After a fibrous insulation batt 20 is compressed in width and inserted into a wall, floor, ceiling or roof cavity having a width less than the resilient fibrous insulation batt 20, even three, four or more inches less, the resilient fibrous insulation batt 20 will expand in width and press against the sides of the cavity to hold or help hold the resilient fibrous insulation batt 20 in place.

Typically, for most applications, such as walls in residential houses, the resilient fibrous insulation batt 20 is about forty-six to about forty-eight inches or about ninetythree to about ninety-six inches in length. Typically, the width of the resilient fibrous insulation batt 20 is equal to or somewhat greater than a standard cavity width for the cavities to be insulated with the baft, e.g. about fifteen inches in width for a cavity where the center to center spacing of the wall, floor, ceiling or roof framing members, e.g. the nominally 2×4, 2×6, 2×8 or 2×10 framing members, is about sixteen inches (the cavity having a width of about fourteen and one half inches) and about twenty three inches in width for a cavity where the center to center spacing of the wall, floor, ceiling or roof framing members e.g. the nominally 2×4, 2×6, 2×8 or 2×10 framing members, is about twenty four inches (the cavity having a width of about twenty two and one half inches). However, for other applications, the resilient fibrous insulation batt 20 may have different widths.

The amount of thermal and/or sound control desired and the depth of the cavities being insulated determine the thickness of the resilient fibrous insulation bafts 20 used to insulate the cavities. Typically, the resilient fibrous insulation batts are about three to about ten inches or more in thickness and approximate the depth of the cavities being insulated. For example, in a wall cavity defined in part by nominally 2×4 or 2×6 inch studs or framing members, a resilient fibrous insulation batt 2 will have a thickness of about three and one half or about five and one half inches, respectively,

In describing the invention, certain embodiments have been used to illustrate the invention and the practices thereof. However, the invention is not limited to these specific embodiments as other embodiments and modifications within the spirit of the invention will readily occur to those skilled in the art on reading the specification. Thus, the invention is not intended to be limited to the specific embodiments disclosed, but is to be limited only by the claims appended hereto.

What is claimed is:

1. A resilient fibrous insulation batt comprising:
a batt of resilient fibrous insulation; the batt having a length, a width and a thickness; the batt having first and second major surfaces that, with respect to each other, lie in substantially parallel planes and that each extend the length and width of the batt; the batt having first and second lateral surfaces that, with respect to each other, lie in substantially parallel planes, that extend for the length of the batt, and that extend between the major surfaces of the batt; the batt having first and second end surfaces that, with respect to each other, lie in substantially parallel planes, that extend the width of the batt, and that extend between the major surfaces of the batt; the fibers of the batt being randomly oriented and entangled together and predominately lying in planes that extend substantially perpendicular to the major surfaces and the end surfaces of the batt and substantially parallel to the lateral surfaces of the batt to facilitate a widthwise compression of the batt.

2. The resilient fibrous insulation batt according to claim 1, wherein:
the fibers are glass fibers.

3. The resilient fibrous insulation batt according to claim 1, wherein:
the fibers are polymeric fibers.

4. The resilient fibrous insulation batt according to claim 1, wherein:
a binder bonds the fibers together at points of intersection.

5. The resilient fibrous insulation batt according to claim 4, wherein:
the fibers are glass fibers.

6. The resilient fibrous insulation batt according to claim 4, wherein:
the fibers are polymeric fibers.

7. The resilient fibrous insulation batt according to claim 1, wherein:
the blanket is binderbess.

8. The resilient fibrous insulation batt according to claim 7, wherein:
the fibers are glass fibers.

9. The resilient fibrous insulation batt according to claim 7, wherein:
the fibers are polymeric fibers.

10. A method of making resilient fibrous insulation batts, comprising:
in a process for making resilient fibrous insulation batts having a length, a width and a thickness; collecting fibers into a continuous blanket of resilient, fibrous insulation having a thickness about equal to the width of the batts being made from the blanket; the blanket having a length and a width; the blanket having first and second major surfaces that, with respect to each other, lie in substantially parallel planes and that each extend the length and width of the blanket; the blanket having first and second lateral surfaces that, with respect to each other, lie in substantially parallel planes, that extend for the length of the blanket, and that extend between the major surfaces of the blanket; the collected fibers of the blanket being randomly oriented and entangled together and predominately lying in planes that extend substantially parallel to the major surfaces of the blanket and substantially perpendicular to the lateral surfaces of the blanket; and
severing the blanket into longitudinally extending blanket sections having lengths, widths and thicknesses equal to the lengths, widths and thicknesses of the insulation batts: a) by forming a first series of longitudinally extending cuts in the blanket that are substantially parallel with respect to each other with the longitudinal cuts extending substantially perpendicular to the major surfaces of the blanket, extending from the first major surface to the second major surface of the blanket, extending substantially parallel to the lateral surfaces of the blanket, and being spaced-apart from each other, across the width of the blanket, distances about equal to the thicknesses of the batts being made from the blanket; and b) by forming a plurality of transversely extending cuts in the blanket that are substantially parallel with respect to each other with the transverse cuts extending substantially perpendicular to the major surfaces and the lateral surfaces of the blanket, extending from the first major surface to the second major surface of the blanket, and being spaced-apart from each other, along the length of the blanket, distances about equal to the lengths of the batts being made from the blanket whereby a plurality of the batts are formed; the batts each having first and second major surfaces that, with respect to each other, lie in substantially parallel planes and that each extend the length and width of the batt; the batts each having first and second lateral surfaces that, with respect to each other, lie in substantially parallel planes, that extend for the length of the batt, and that extend between the major surfaces of the batt; the batts each having first and second end surfaces that, with respect to each other, lie in substantially parallel planes, that extend the width of the batt, and that extend between the major surfaces of the batt; the fibers of each of the batts being randomly oriented and entangled together and predominately lying in planes that extend substantially perpendicular to the major surfaces and the end surfaces of the batt and substantially parallel to the lateral surfaces of the batt to facilitate a widthwise compression of the batt.

11. The method of making resilient fibrous insulation batts according to claim 10, wherein:
the fibers are glass fibers.

12. The method of making resilient fibrous insulation batts according to claim 10, wherein:
the fibers are polymeric fibers.

13. The method of making fibrous insulation batts according to claim 10, including:
applying a binder to the fibers as the blanket is formed whereby the binder bonds the fibers together at points of intersection.

14. The method of making fibrous insulation batts according to claim 13, wherein:
the fibers are glass fibers formed by a rotary fiberization process.

15. The method of making fibrous insulation batts according to claim 13, wherein:
the fibers are polymeric fibers formed by a rotary fiberization process.

16. The method of making fibrous insulation batts according to claim 10, wherein:
no binder is applied to the fibers as the blanket is formed and the blanket is binderless.

17. The method of making fibrous insulation batts according to claim 16, wherein:
the fibers are glass fibers formed by a rotary fiberization process.

18. The method of making fibrous insulation batts according to claim 16, wherein:
the fibers are polymeric fibers formed by a rotary fiberization process.
